(19) United States
(12) Patent Application Publication
(10) Pub. No.: US 2025/0129253 A1
(43) Pub. Date: Apr. 24, 2025

(54) Modified layered silicate novel barrier and shielding pigment and method thereof

(71) Applicant: ZHEJIANG FENGHONG NEW MATERIALS CO., LTD, Huzhou (CN)

(72) Inventors: Chunwei WANG, Huzhou (CN); Jinling LIU, Huzhou (CN); Yu CHENG, Huzhou (CN); Yinglei WU, Huzhou (CN); Qi HUA, Huzhou (CN); Jingjing LI, Huzhou (CN); Jun LUO, Huzhou (CN); Hong SUN, Huzhou (CN); Zexiong ZHOU, Huzhou (CN)

(73) Assignee: ZHEJIANG FENGHONG NEW MATERIALS CO., LTD, Huzhou (CN)

(21) Appl. No.: 19/000,530

(22) Filed: Dec. 23, 2024

Related U.S. Application Data
(63) Continuation of application No. PCT/CN2022/132917, filed on Nov. 18, 2022.

(51) Int. Cl. C09D 5/08; B01F 23/53; B01F 23/80; B01F 27/091; B01F 27/1152; B01F 27/13; B01F 27/192; B01F 27/806; B01F 27/93; B01F 27/96; B01F 35/32; B01F 101/30; C01B 33/44; C09D 1/00

(52) U.S. Cl. CPC C09D 5/086; B01F 23/53; B01F 23/81; B01F 27/091; B01F 27/1152; B01F 27/13; B01F 27/192; B01F 27/806; B01F 27/93; B01F 27/96; B01F 35/32045; B01F 35/323; C01B 33/44; C09D 1/00; B01F 2101/30; B01F 2215/044; B01F 2215/0472; B01F 2215/0477

(57) ABSTRACT

The present invention relates to a kind of pigment preparation, in particular to a modified layered silicate novel barrier and shielding pigment and its preparation method. It is a layer silicate with exchangeable anticorrosive ions as a template, using metal oxides or metal salts, inorganic acids to synthesize nano-spherical zinc phosphate, phosphate, molybdate, borate or tungstate, with rare earth cerium, strontium, lanthanum or praseodymium doped modification of the pigment. The invention uses silicate as a template to effectively control the agglomeration of nanoparticles during the liquid phase deposition process, avoiding the multiple cleaning and sewage treatment processes required by using surfactants and solvents. What is more valuable is lamellar silicic acid. The salt itself has certain anti-corrosion properties and is economical. At the same time, the physical barrier and exchangeable anti-corrosion ions of the lamellae further improve the anti-corrosion properties of the pigment, making the pigment highly active and shielding.

### RELATED APPLICATIONS

The present patent document is a continuation of PCT Application Serial No. PCT/CN2022/132917, filed Nov. 18, 2022, designating the United States and published in English, which is hereby incorporated by reference.

### BACKGROUND

### 1. Technical Field

The present invention relates to a kind of pigment preparation, in particular to a modified layered silicate novel barrier and shielding pigment and its preparation method.

### 2. Background Information

According to a survey by the international association of corrosion engineers (NACE), global losses due to metal corrosion amount to US $2.5 trillion every year, which is approximately equivalent to 3.4% of global GDP. At present, 75% of metal surface protection uses paint coating for anti-corrosion. The core material is anti-corrosion pigment. The mechanism and type of anti-corrosion pigment are: physical barrier type, high-diameter-thickness ratio layered materials, such as glass flakes, mica iron oxide, layered Silicate clay, etc., delays the occurrence of corrosion by blocking corrosive substances such as oxygen and moisture from passing through the coating; electrochemical protection type, such as zinc powder, which is more active than steel and protects the steel substrate with sacrificial anode action; chemical shielding type, such as red lead, phosphate, chromate, molybdate and ion exchange pigments, when corrosion occurs, control the generation of rust through complexation and produce insoluble matter that is deposited where corrosion occurs, forming a shielding layer to avoid further corrosion.

Red lead, zinc chromium yellow and strontium chromium yellow have been banned globally because they contain heavy metals lead and chromium. The amount of zinc powder added needs to be more than 70% and the cost is high, which limits its scope of use. The price of ion exchange pigments is high, and the anti-corrosion and anti-rust properties of zinc phosphate and phosphate are much different than those of chromate. In recent years, industry insiders have studied nano-zinc phosphate and phosphate anti-corrosion pigments in the hope of improving the anti-rust performance and completely replacing chromate. For example, CN107699033 disclosed the preparation of composite nano-zinc phosphate anticorrosive pigment below 100nm by sanding and spray drying with ordinary zinc phosphate anticorrosive pigment and organic anticorrosive pigment, and the salt spray resistance was significantly improved. M. Jamil et al. used layered silicate montmorillonite as a template to synthesize nano-calcium phosphate in the 2022 cell press magazine “Apatitic calcium phosphate/montmorillonite nano-biocomposite: in-situ synthesis, characterization and dissolution properties”, the particle size is in about 20 nm, calcium phosphate has regular shape and uniform size.

CN1147001 discloses that lamellar carrier materials (natural or synthetic mica, talc, kaolin, glass platelets, etc.) and the combination of active pigments (zinc phosphate, zinc borate, calcium metaphosphate and phthalocyanine can form water-insoluble substances with iron, bonding hydroxide ions and pH microbuffer system materials), the proportion of lamellar carrier materials and active pigments is 10%-80%:20%-90%, the amount of combined materials added in the paint is 10%-45%, the process can be a single component respectively sanded or ground to the required fineness, and then mixed to configure the paint; It can also be a single component added sequentially to the paint binder and then sanded or ground together.

CN114364752 discloses a composite ion exchange pigment with intelligent effect. The zeolite in the component contains exchangeable cations such as calcium, magnesium, barium, aluminum, zinc, iron, cerium, lanthanum, etc, and another component of hydrotalcite contains exchangeable anions such as phosphate radical, molybdate radical, phosphite radical, pyrophosphate radical, metaphosphate radical, tripolyphosphate radical, metaborate radical, chromate radical, etc. The flaky hydrotalcite has a barrier effect and delays the passage of corrosive substances through the coating. When corrosive electrolyte enters the coating (such as chloride ions or sodium ions) are exchanged and adsorbed during the process of penetrating into the coating, and corresponding anti-corrosion anions and cations are released, and precipitate in the coating to seal the gaps in the coating, or transfer it forms a protective layer on the metal substrate, thereby acting as a barrier to protect the substrate and enhancing the adhesion of the coating.

TABLE 1
lists the composition structure, action principle and advantages
and disadvantages of commonly used anticorrosive pigments.

| Products | Chemical | | Advantages |
|---|---|---|---|
| and | Components | | and |
| Tech- | and | | Dis- |
| nologies | Structures | Action Principles | advantages |
| Zinc | Irregular | Standard electrode potential | Easy to detect |
| Powder | metal | (−0.76 V) is lower than that of | and control |
| | element | steel (−0.44 V), zinc powder is | High addition, |
| | particles | corroded and sacrificed on | requires |
| | | the anode first to protect the | 80% or |
| | | metal substrate | more |
| Zinc | Zinc | Chromate ions form insoluble | Performance |
| chromate, | chromate, | chromate iron on the anode | stable |
| strontium | strontium | with iron ions, zinc and | Class 1 |
| chromate | chromate | strontium ions form hydroxide | carcinogen, |
| | | passivation film on the | strontium |
| | | cathode | price |
| | | | high |
| Molybdate | Molybdate | Molybdate ions form insoluble | Color light |
| zinc | zinc | molybdate iron on the anode | High price |
| | | with iron ions, zinc ions form | |
| | | hydroxide passivation film on | |
| | | the cathode | |
| Phosphate | Phosphate | Molybdate ions form insoluble | Performance |
| zinc | zinc, average | molybdate iron on the anode | balanced |
| | 5-10 um | with iron ions, zinc ions form | Long-term |
| | square | hydroxide passivation film on | toxicity |
| | particle | the cathode | in aquatic |
| | | | ecosystems |
| Silica ion | Calcium- | When corrosive substances | Low toxicity |
| exchange | loaded silica, | enter the coating, calcium | and |
| pigment | average | ions are exchanged out, | environ- |
| | particle size | producing calcium hydroxide | mentally |
| | 3-5 um | and ferric silicate | friendly |
| | spherical | precipitation, forming a | Reduces the |
| | particles | passivation film | gloss of |
| | | | topcoat, |
| | | | affects |
| | | | the curing |
| | | | of some |
| | | | coatings |
| Organic | aliphatic | Organic amines with a | Low addition |
| amines | amines, | nitrogen atom that has a lone | levels |
| | cycloaliphatic | pair of electrons are powerful | Volatile |
| | amines, | adsorption centers. They | and easily |
| | aromatic | replace water on the metal | leached |
| | amines, | surface with organic amines, | |
| | heterocyclic | preventing corrosion from | |
| | amines, | occurring | |
| | quaternary | | |
| | ammonium | | |
| | salts, etc | | |

### BRIEF SUMMARY

The first technical object of the present invention is to provide a modified layered silicate novel barrier and shielding pigment.

The second technical object of the present invention is to provide a method for preparing a modified layered silicate novel barrier and shielding pigment.

The first technical purpose of the present invention is achieved through the following technical solutions:

Modified layered silicate novel barrier and shielding pigment is a kind of pigment which is synthesized by liquid phase deposition of nano-spherical zinc phosphate, phosphate, molybdate, borate or tungstate with metal oxide or metal salt and inorganic acid, and doped with rare earth cerium, strontium, lanthanum or praseodymium.

The invention enables the pigment to have high activity and shielding ability, and at the same time, the physical barrier and exchangeable anti-corrosion ions of the lamellae further improve the anti-corrosion performance of the pigment. Using sheet silicate as a template can effectively control the agglomeration of nanoparticles during liquid deposition, avoiding the multiple cleaning and sewage treatment processes required by using surfactants and solvents. What is more valuable is sheet silicate salt itself has certain antiseptic properties and is economical.

Preferably, the modified layered silicate novel barrier and shielding pigment is based on the grafting of organic amine corrosion inhibitor and layered silicate by condensation reaction with phosphoric acid, and the neutralization or metadecomposition reaction of active oxide or its sulfuric acid, nitric acid and hydrochloride with inorganic acid or precipitation reaction with salt to generate nano-level phosphoric acid, molybdic acid, tungstic acid or borate, which are deposited on the surface of layered silicate lamellae. Select rare earth oxides or their sulfuric acid, nitric acid and hydrochloride doping modification.

Modified layered silicate novel barrier and shielding pigments use different silicate template agents and are combined with metal oxides or metal salts, inorganic acids and rare earth oxides to derive multiple series of products.

Pigments that use mica as template agent also have good UV absorption characteristics. Pigments that use montmorillonite and kaolin as template agents have good barrier and acid and alkali resistance due to their high diameter-to-thickness ratio. Metal oxides or metal salts can be selected, and chromium-free and zinc-free anticorrosive pigments can be prepared by excluding zinc and chromium, which comply with regulatory requirements such as the 2011/65/EU directive.

The second technical purpose of the present invention is achieved through the following technical solutions:

The preparation method of the modified layered silicate novel barrier and shielding pigment includes the following steps:
A. prepare metal oxides or their vitriol, nitric acid and hydrochloride or hydroxide in 30-200 parts by weight, swelling with 150-800 parts by weight of water, high speed dispersion, filtration to remove coarse particles of impurities, viscosity is too high to replenish water to maintain flow capacity;
B. prepare 10-40 parts by weight of organic amine corrosion inhibitor, 100-600 parts by weight of water, dissolve in 3-7 minutes, 20-80 parts by weight of 80-90% phosphoric acid, add and stir for 3-8 minutes; 40-150 parts by weight of layered silicate and 200-750 parts by weight of water to make silicate slurry, disperse the two at high speed for 25-35 minutes, stir at low speed for 1-3 hours, and add 50-220 parts by weight of inorganic acid or inorganic acid salt, add the slurry prepared in step a, stir for 20-40 minutes, grind for 25-35 minutes, add 3.5-21 parts by weight of rare earth oxides or their vitriol, nitric acid and hydrochlorides, 3-22 parts by weight of inorganic acid or inorganic acid salt, continue to disperse at high speed, react for 3-5 hours, wash and centrifuge, dry and grind at 70-320° C.

The present invention uses silicate as a template to effectively control the agglomeration of nanoparticles during the liquid phase deposition process, avoiding the multiple cleaning and sewage treatment processes required by using surfactants and solvents. What is more valuable is lamellar silicic acid. The salt itself has certain anti-corrosion properties and is economical. At the same time, the physical barrier and exchangeable anti-corrosion ions of the lamellae further improve the anti-corrosion properties of the pigment, making the pigment highly active and shielding.

The amino group in organic amines has chemical adsorption and physical adsorption. It can be adsorbed on the metal surface to form a protective film or form a chelate protective film with ions on the metal surface. After the organic amine is adsorbed on the metal surface, it will An adsorption film is formed, and the alkyl groups in the adsorption film play a shielding role, preventing corrosive substances such as water, chloride ions, and oxygen from contacting the metal, thereby preventing metal corrosion. Because it acts at the molecular level, the anti-corrosion efficiency is very high, and a very good protective effect can be achieved with an addition amount of about 100 ppm. However, organic amines are easy to volatilize and dissolve and lose. They can only temporarily delay corrosion and lack persistence. They are currently widely used corrosion inhibitors.

Modified by alkaline earth metal or rare earth metal ions such as calcium, zinc or cerium, which can form insoluble hydroxides, the plasma exchange material of mont morillonite or zeolite or silica gel can be used as an ion exchange anti-rust pigment. When the corrosive electrolyte enters the coating, it is in contact with the anti-rust pigment, and the pigment will capture the corrosive ions on the surface of the ion exchange material. And release the corresponding calcium ions or other ions transferred to the metal substrate, when this process continues, calcium ions or other ions form hydroxide precipitation deposited on the interface between the metal and the coating, thus acting as a barrier to protect the substrate, and enhance the adhesion of the coating, so that the corrosion resistance of the coating is greatly enhanced.

The invention forms ionic bonding between organic amine and phosphoric acid, and condensation of the remaining phosphoric carboxyl group with the silicon hydroxyl group of the end face of the layered silicate such as montmorillonite and vermiculite to form Si—O—P bridge structure, so that the organic amine is firmly bound to the surface of the layered silicate and has a lasting anti-corrosion effect, and the modified layered silicate is used as a template agent to synthesize the nano-sized anti-rust pigment by liquid deposition method. Modified with rare earth doping. The novel anti-rust pigment of the invention has the functions of ion exchange, blocking and shielding.

Preferably, the active oxide in step A or its sulfuric acid, nitric acid and hydrochloride or hydroxide are one or more of calcium hydroxide, calcium oxide, magnesium hydroxide, magnesium oxide, barium hydroxide, aluminum hydroxide, aluminum oxide, iron oxide.

Preferably, the organic amine corrosion inhibitor in step B is one or more of melamine, ethanolamines, 8-hydroxyquinoline, isopropanolamines, benzotriazoles or benzimidazoles.

Preferably, the layered silicate in step B is one or more of montmorillonite, vermiculite, mica, kaolin, illite, aemon mixed layer or chlorite.

Preferably, the inorganic acid in step B is one or more of phosphoric acid, molybdic acid, tungstic acid or boric acid.

Preferably, the rare earth oxide in step B is one or more of cerium oxide, lanthanum oxide, strontium oxide or praseodymium oxide.

Preferably, the preparation method of the modified layered silicate novel barrier and shielding pigment includes the following steps:
A. prepare 117 parts by weight of active oxide calcium hydroxide, swell with 360 parts by weight of water, stir to disperse completely, filter to remove coarse impurities, if the viscosity is too high, add water to maintain fluidity, and store overnight;
B. 36 parts by weight organic amine corrosion inhibitor melamine, 600 parts by weight water, 5 minutes to dissolve, 70 parts by weight 85% phosphoric acid, add and stir for 5 minutes; After 100 weight parts of layered silicate powder (dry powder) and 300 weight parts of water were made into layered silicate slurry, the two were dispersed at high speed for 30 minutes, stirred at low speed for 2 hours, added 121 weight parts of inorganic acid phosphoric acid, along with calcium hydroxide slurry, stirred at medium speed for 30 minutes, ground by colloidal mill for 30 minutes, and added 10.1 weight parts of rare earth cerium oxide. 8.9 g inorganic acid, continue to alternate grinding for 30 minutes, reaction 4 hours after washing centrifugation three times, 75° C. drying and grinding.

Preferably, the preparation method of the modified layered silicate novel barrier and shielding pigment uses a solid-liquid dispersion high-speed homogenizer for high-speed dispersion, including:
lifting mechanism, the lifting mechanism is a hydraulic cylinder;
rotary drive assembly, the rotary drive assembly is fixed on the top of the hydraulic cylinder, the hydraulic cylinder pushes the rotary drive assembly to perform lifting movement, and the rotary drive assembly includes the driving part, belt, driving wheel and driven wheel, the driving part drives the driving wheel to rotate, and the driving wheel drives the driven wheel through the belt rotate, the output shaft of the driven wheel is connected with the agitator output assembly, thereby driving the agitator output assembly to rotate;
detachable stirring assembly, the detachable stirring assembly is connected and fixed with the agitator output component, the rotation of the stirrer output component drives the detachable stirring assembly to rotate to disperse the solid-liquid mixture evenly;
flip-type material cylinder assembly, the flip-type material cylinder assembly includes a material cylinder, and the detachable stirring assembly is inserted into or away from the material cylinder, under the push of the hydraulic cylinder when the detachable stirring assembly is inserted into the material cylinder, it is used to mix the solid-liquid mixture in the material cylinder.

During the use of the solid-liquid dispersion high-speed homogenizer in the prior art, since the stirring component only has a dispersing disk, and the dispersing disk is an integrated structure, it is inconvenient to disassemble and clean. Moreover, the existing high-speed disperser cannot dissolve solid and liquid into one efficiently, quickly and uniformly, so that the material cannot effectively produce liquid layer friction, impact tearing, turbulence and other comprehensive effects in a narrow space. Due to repeated cycles of dispersion and shearing, the product stability still needs to be improved and the dispersion efficiency is low.

The solid-liquid dispersion high-speed homogenizer of the present invention is composed of a lifting mechanism, a rotary drive assembly, a detachable stirring assembly and a flip-type material cylinder assembly. The detachable stirring assembly is installed on the rotary drive assembly and driven by the rotary drive assembly. Rotation, the material is fully dispersed during the rotation process, and the lifting mechanism promotes the lifting and lowering of the rotating drive assembly, thereby driving the detachable stirring assembly to lift and perform two movements: inserting into the inside of the flip-type material cylinder assembly or moving away from the flip-type material cylinder assembly;

After the rotary drive assembly is inserted into the slot of the detachable stirring assembly through the positioning plug block on the rotary drive assembly, the positioning plug block is connected and fixed with the butt post through the bolts and nuts penetrating the positioning plug block and the butt post, so as to facilitate the installation and disassembly of the detachable stirring assembly, and facilitate the disassembly and cleaning of the detachable stirring assembly. The exterior of the detachable stirring assembly is designed as a frame type tilting mixing. The high shear dispersion of the middle dispersing disk makes the solid liquid of the medium and high viscosity materials mixed, and the fork stirring blade is used to disperse and stir evenly to achieve the ideal material mixing effect. The mixing effect is good and the homogenization effect is good. The flip-type material cylinder assembly is designed as a reversible structure to facilitate the flip cleaning and cleaning after unloading.

As a further optimization of the technical scheme, the lifting mechanism also comprises a vertical outer housing fixed on the outer side of the hydraulic cylinder, three sets of cross-shaped guide opening slots arranged on the left side of the vertical outer housing, a docking component with a hoop on the side of the vertical outer housing and a fixed ring on the outer side of the material cylinder, and a base fixed on the bottom of the vertical outer housing. The horizontal section of the vertical outer housing is a U shape formed by a semi-circle and a rectangle.

As a further optimization of the technical scheme, the docking component comprises a limiting plate on the left side of the vertical outer housing, a U-shaped hoop on the side of the vertical outer housing with both ends passing through the limiting plate, three sets of cross-shaped plug blocks fixed on the right side of the limiting plate and matched with three sets of cross-shaped guide opening slots to each other, and a U-shaped slot insert fixed on the left side of the limiting plate. On the left side of the limiting plate and at both ends of the U-shaped hoop are screw connected with a locking nut fastening the U-shaped slot insert block to the vertical outer housing;

After the insert block on the fixed ring is inserted into the notch in the U-shaped slot insert block, the fixed ring is fixed on the docking component through bolts that penetrate the insert block and the U-shaped slot insert block.

As a further optimization of the technical scheme, the rotary drive assembly also comprises a transverse installation box fixed at the end of a hydraulic cylinder piston rod, a circular table connecting seat arranged below the left end of the transverse installation box and fixed with the shaft of the driven wheel, a connecting rod fixed at the bottom of the circular table connecting seat and a positioning plug block fixed at the bottom of the connecting rod. The driving wheel rotation is arranged on the right end of the transverse installation box, the driven wheel rotation is arranged on the left end of the transverse installation box, the driving part is fixed on the bottom of the right end of the transverse installation box, the driving part is a drive motor, and the connecting rod is rotated with the cylinder cover through the bearing.

As a further optimization of this technical solution, The detachable stirring assembly comprises a butt post with a slot, a mixing rod fixed under the butt post, two sets of dispersing disks symmetrically fixed on the outer surface of the mixing rod, a sleeve with a limit socket on the outer side of the bottom end of the mixing rod and locked by locking screws, two sets of inverted U-shaped mounting plates arranged on the left and right sides of the sleeve, and two sets of inverted U-shaped mounting plates fixed on the outer side of the top of the two sets of inverted U-shaped mounting plates and inverted U-shaped The mounting plate is fitted with two side plates forming a frame mixing rod, two bottom scraper plates bolted to the bottom of the inverted U-shaped mounting plate for scraping the material stuck to the bottom wall of the material cylinder, a side scraping plate bolted to the outside side of the two side plates for scraping the material stuck to the side wall of the material cylinder, and two sets of fork stirring blades which are symmetrical and fixed to the side scraper plate;

The flanging of the outer sides of the two side plates is connected with the flanging screw on the butt plate outside the top of the mixing rod through a bolt, and the top of each group of the inverted U-shaped mounting plate is fixed connected with a reinforcing plate connected with the sleeve, and the sleeve is limited under the limit ring on the outer side of the mixing rod;

After the positioning plug block is inserted into the slot, the positioning plug block is connected and fixed with the butt post through the bolts and nuts penetrating the positioning plug block and butt post.

As a further optimization of the technical scheme, the flip-type material cylinder assembly comprises a flip board fixed at the bottom of the material cylinder and a push assembly to push the flip board. The bottom of the flip board is arranged longitudinally on the left side of three groups of first convex font blocks, and the bottom of the flip board is arranged on the right side of the three groups of first convex font blocks. Three groups of second convex font blocks are fixed through the longitudinal axis;

The driving assembly comprises two U-shaped fixing slots arranged symmetrically before and after, two first rectangular slots fixed on the left end of the top of the two U-shaped fixing slots, three groups of bearing blocks fixed on the top of the two first rectangular slots and arranged longitudinally, a rotating shaft connected with the three groups of bearing blocks, an L-type fixing seat fixed on the two first rectangular slots and a motor fixed on the top of the L-type fixing seat The worm gear and worm reducer is connected with the output shaft drive of the motor, and the force arm connecting rod is fixed with the output shaft of the worm gear and worm reducer;

The sleeve ring on the force arm connecting rod rotates and is connected to the outer side of the longitudinal shaft, and three groups of first convex font blocks are fixed and connected to the outer side of the rotating shaft;

The left and right ends of the two U-shaped fixing slots are fixed with support foot, the front and back sides of the two first convex font block external sides are respectively fixed with two square fixing plate, two square fixing plate at the bottom of the vertical plate is fixed with a guide block, the two U-shaped fixing slot left end of the outer connecting block with two curved guide plate is fixed connected, respectively. The guide block is matched with the curved guide plate to limit the guide slide, the curved guide plate is arranged with the guide block to insert the arc-shaped guide through-hole slot, the top of the turning plate is arranged with the material cylinder positioning fixed positioning parts, the top right end of the two U-shaped fixing slots is also fixed with a second rectangular slot.

To sum up, the present invention has the following beneficial effects:
1. The present invention uses silicate as a template to effectively control the agglomeration of nanoparticles during the liquid phase deposition process, avoiding the multiple cleaning and sewage treatment processes required by using surfactants and solvents. What is more valuable is that the lamellar silicate itself has certain anti-corrosion properties and is economical. At the same time, the physical barrier and exchangeable anti-corrosion ions of the lamellae further improve the anti-corrosion properties of the pigment, giving the pigment high activity and shielding ability;
2. The high speed homogenizing machine for solid-liquid dispersion has the advantages of uniform dispersion and agitation, good mixing effect and good homogenization effect, and the component of the flip-type material cylinder assembly is designed as a reversible structure, which is convenient for flipping and cleaning after unloading. Thus, the dispersion efficiency is high and the stability of the final prepared product is good.

### BRIEF DESCRIPTION OF THE DRAWINGS

FIG. 1 is the SEM electron microscope image of the mica template agent;

FIG. 2 is the SEM electron microscope image of the mica template agent after liquid phase chemical deposition, with phosphocerium-doped nanophosphate particles on the template surface with a size of about 30-100 nm;

FIG. 3 is the SEM electron microscope image of the bentonite template agent;

FIG. 4 is the SEM electron microscope image of the bentonite template agent after liquid phase chemical deposition, with phosphocerium-doped nanophosphate particles on the template surface with a size of about 30-100 nm;

FIG. 5 is a schematic diagram of the structure of the invention;

FIG. 6 is a schematic diagram of the decomposition of FIG. 5 of the invention;

FIG. 7 is a schematic diagram of the structure of the hydraulic cylinder of the invention;

FIG. 8 is a schematic diagram of the structure of the docking component of the invention;

FIG. 9 is a schematic diagram of the structure of the rotary drive assembly of the invention;

FIG. 10 is a schematic diagram of the structure of the cylinder cover of the rotary drive assembly of the invention after disassembly;

FIG. 11 is a schematic diagram of the structure of the detachable stirring assembly of the invention;

FIG. 12 is a schematic diagram of the structure of the connecting rod and butt post in the invention;

FIG. 13 is a schematic diagram of the structure of the flip-type material cylinder assembly of the invention;

FIG. 14 is a schematic diagram of the structure of the tilting plate of the invention;

FIG. 15 is a schematic diagram of the structure of the pushing component of the invention;

FIG. 16 is a corrosion rate curve diagram of the electrochemical performance of the coating product of Example 1 of the invention;

FIG. 17 is a salt spray resistance test of 240h of the acrylic paint;

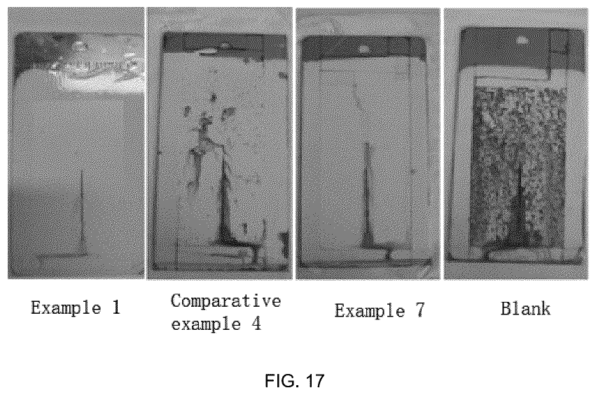

FIG. 18 is a salt spray resistance test of 960h of the epoxy paint.

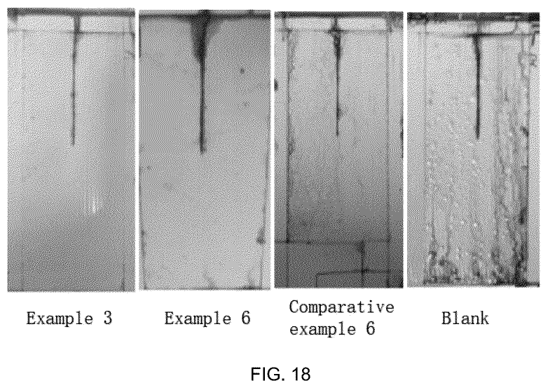

In the picture: 1. lifting mechanism; 101. hydraulic cylinder; 102. vertical outer housing; 103. cross-shaped guide opening slot; 104. docking component; 105. limiting plate; 106. U-shaped hoop; 107. cross-shaped plug block; 108. U-shaped slot insert block; 109. locking nut; 110. base; 2. rotary drive assembly; 201. driving part; 202. belt; 203. driving wheel; 204. driven wheel; 205. transverse installation box; 206. circular table connecting sea; 207. connecting rod; 208. positioning plug block; 209. cylinder cover; 3. detachable stirring assembly; 301. slot; 302. butt post; 303. mixing rod; 304. dispersing disk; 305. locking screw; 306. inverted u-shaped mounting plate; 307. side plate; 308. bottom scraper plate; 309. side scraper plate; 310. fork stirring blade; 311. sleeve; 312. butt plate; 313. reinforcing plate; 314. limit ring; 4. flip-type material cylinder assembly; 401. material cylinder; 402. fixed ring; 403. insert block; 404. flip plate; 405. push assembly; 406. first convex font block; 407. second convex font block; 408. longitudinal axis; 410. U-shaped fixing slot; 411. first rectangular slot; 412. bearing block; 413. rotating shaft; 414. L-type fixing seat; 415. motor; 416. worm gear and worm reducer; 417. force arm connecting rod; 418. support foot; 419. sleeve ring; 420. square fixing plate; 421. vertical plate; 422. guide block; 423. connecting block; 424. curved guide plate; 425. arc-shaped guide through-hole slot; 426. second rectangular slot.

### DETAILED DESCRIPTION OF THE DRAWINGS AND THE PRESENTLY PREFERRED EMBODIMENTS

### Example 1

Preparation of calcium hydroxide slurry A: 117 kg of calcium hydroxide, swell with 360 kg of water, stir to disperse completely, filter to remove coarse impurities, and add water if the viscosity is too high to maintain fluidity.

36 kg of organic amine inhibitor melamine, 600 kg of water, 5 minutes to dissolve, 70 kg of 85% phosphoric acid, add and stir for 5 minutes. After 100 kg 325 mesh montmorillonite powder (dry powder) and 300 kg water were made into montmorillonite slurry, the two were mixed at high speed for 30 minutes and stirred at low speed for 2 hours. The organic amine corrosion inhibitor was grafted on the end face of montmorillonite by condensation reaction with phosphoric acid, and 121 kg of inorganic acid phosphoric acid was added along with calcium hydroxide slurry A, stirring at medium speed for 30 minutes. High-speed dispersion grinding for 30 minutes, add 10.1 kg of rare earth cerium oxide, 8.9 g phosphoric acid, continue high-speed dispersion grinding for 30 minutes, reaction 4 hours after washing centrifuge three times, drying at 70° C. and grinding to less than 325 mesh.

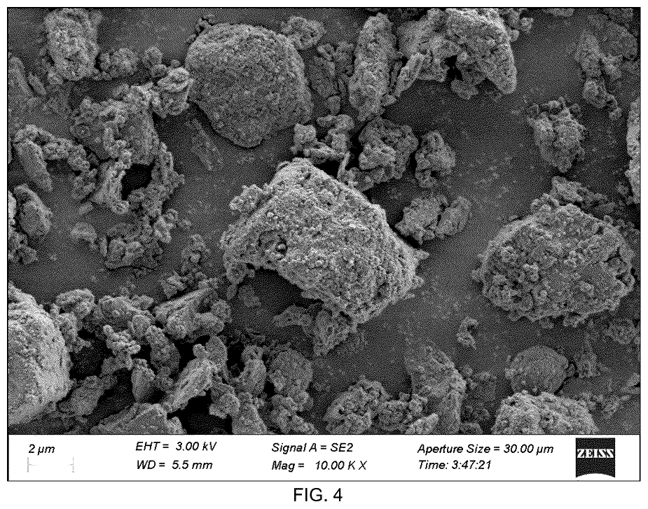

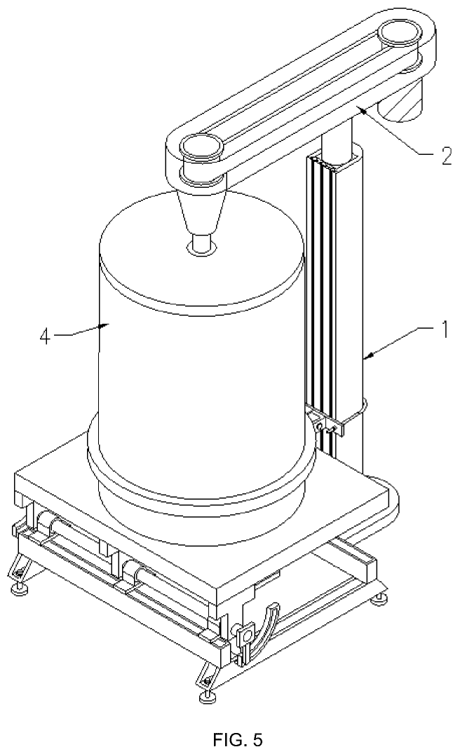

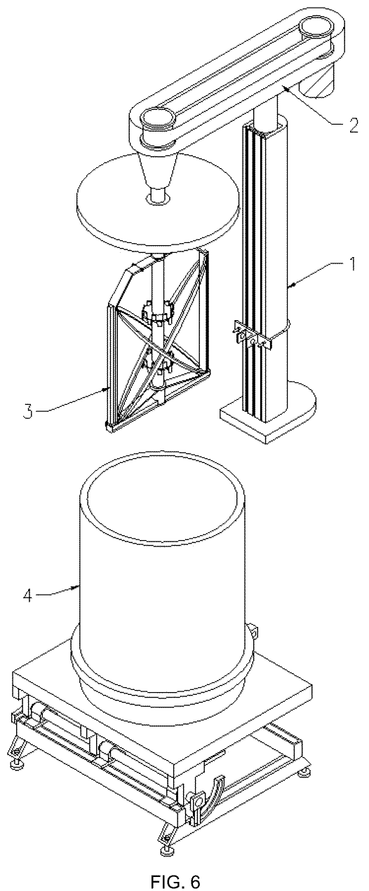

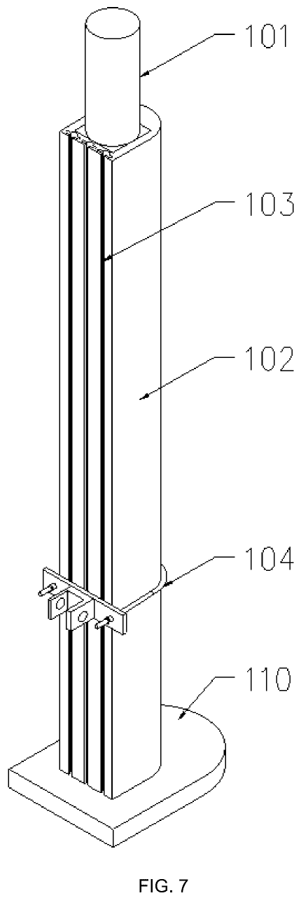

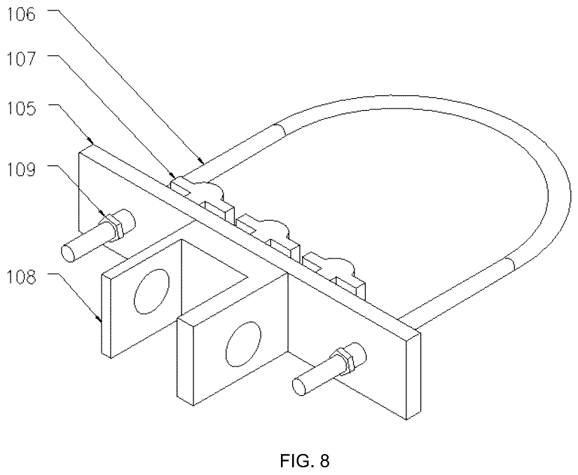

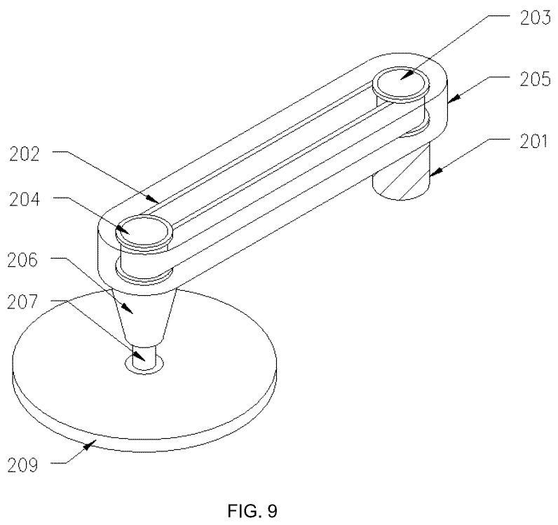

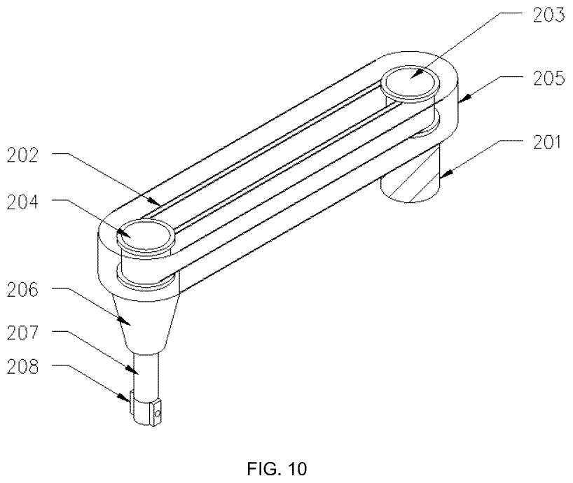

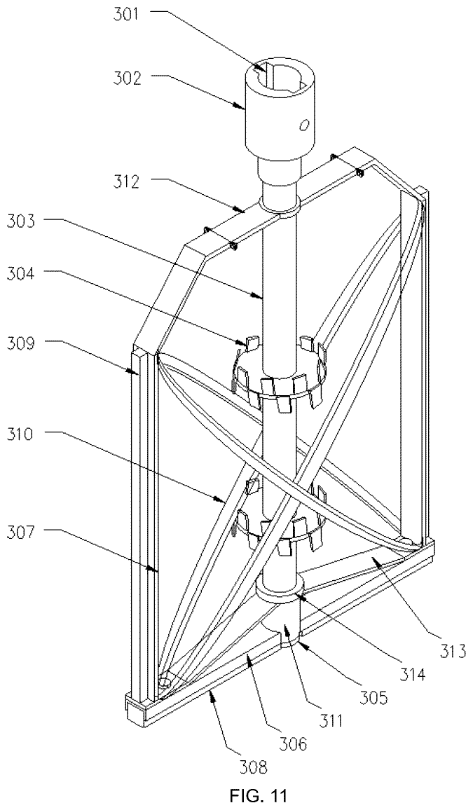

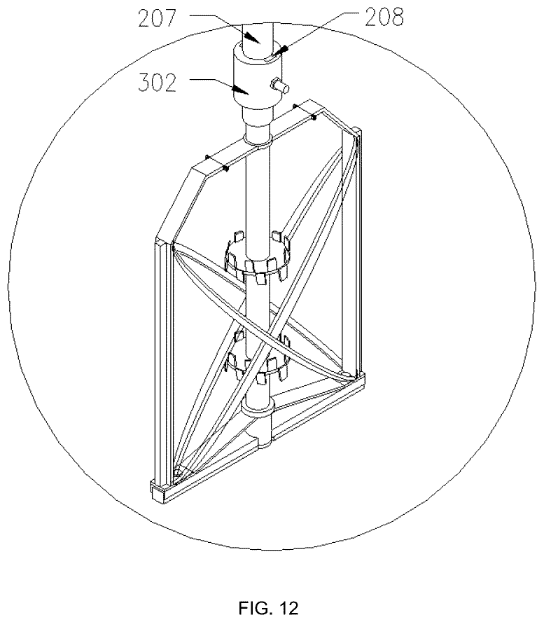

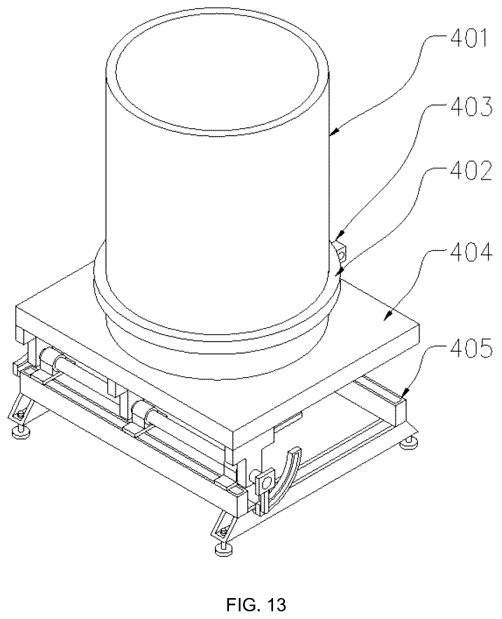

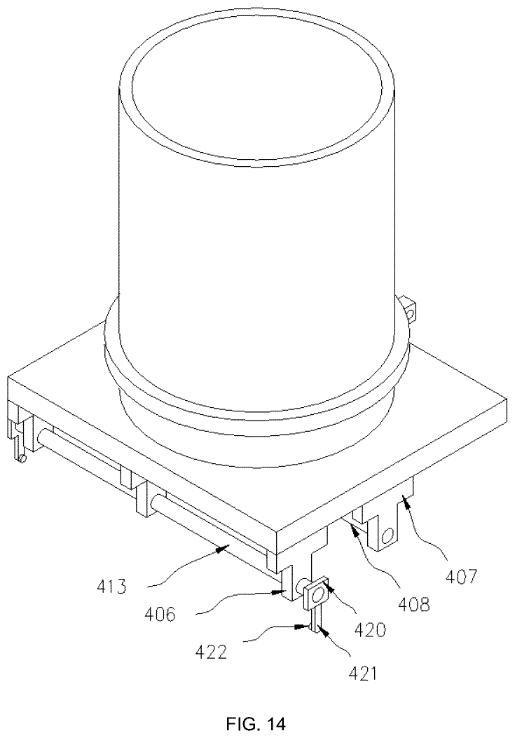

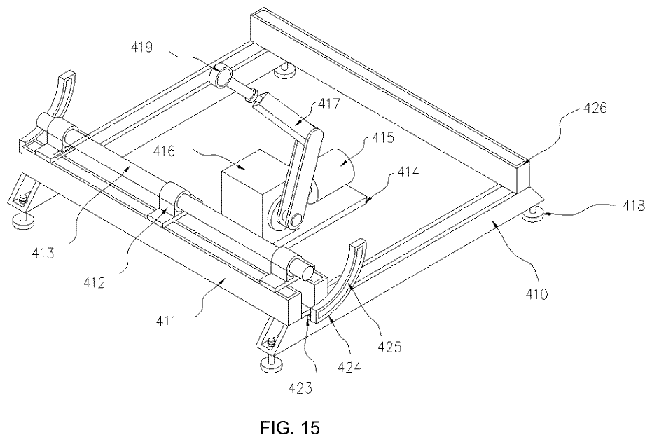

As shown in FIG. 4-15, a solid-liquid dispersion high-speed homogenizer used for high-speed dispersion comprises a lifting mechanism 1, a rotary drive assembly 2, a detachable stirring assembly 3 and a flip-type material cylinder assembly 4. The detachable stirring assembly 3 is installed on the rotary drive assembly 2, and is driven by the rotary drive assembly 2 to rotate, and the materials are fully dispersed in the rotating project. The lifting mechanism 1 pushes the rotary drive assembly 2 up and down, thereby driving the detachable stirring assembly 3 up and down, and carries out two movements of inserting the flip-type material cylinder assembly 4 inside or away from the flip-type material cylinder assembly 4;

Lifting mechanism 1 is hydraulic cylinder 101, The lifting mechanism 1 also includes a vertical outer housing 102 fixed on the outer surface of the hydraulic cylinder 101, three sets of cross-shaped guide opening slots 103 arranged on the left side of the vertical outer housing 102, a docking component 104 with a hoop on the outer side of the vertical outer housing 102 and a fixed ring 402 on the outer surface of the material cylinder 401, and a base 110 fixed on the bottom of the vertical outer housing 102. The horizontal section shape of the vertical outer housing 102 is a U shape formed by a semi-circle and a rectangle;

The docking component 104 comprises a limiting plate 105 located on the left side of the vertical outer housing 102, a U-shaped hoop 106 located on the outer side of the vertical outer housing 102 with both ends passing through the limiting plate 105, three sets of cross-shaped plug block 107 fixed on the right side of the limiting plate 105 and matched with three sets of cross-shaped guide opening slot 103 to each other, and fixed on the limiting plate 105 U-shaped slot insert block 108 on the left side, a limiting plate 105 on the left side and both ends of the U-shaped hoop 106 are screw connected with a locking nut 109 that U-shaped hoop 106 to the vertical outer housing 102;

After the insert block 403 on the fixed ring 402 is inserted into the slot in the U-shaped slot insert block 108, the fixed ring 402 is fixed on the docking component 104 through bolts penetrating the insert block 403 and the U-shaped slot insert block 108.

Since the docking component 104 is fixedly connected to the outer side of the vertical outer housing 102 through the cooperation of the U-shaped hoop 106 and the limiting plate 105, it is convenient to adjust the installation height of the docking component 104 according to different installation requirements. The adjustment is convenient and the scope of application is expanded;

The rotary drive assembly 2 is fixed on the top of the hydraulic cylinder 101, and the hydraulic cylinder 101 drives the rotary drive assembly 2 to carry out lifting movement, and the rotary drive assembly 2 comprises a driving part 201, a belt 202, a driving wheel 203 and a driven wheel 204, and the driving part 201 drives the driving wheel 203 to rotate, and the driving wheel 203 drives the driven wheel 204 to rotate through the belt 202. The output shaft of the driven wheel 204 is connected with the agitator output assembly to drive the agitator output assembly to rotate;

The rotary drive assembly 2 also includes a transverse installation box 205 fixed to the piston rod end of the hydraulic cylinder 101, a circular table connecting seat 206 arranged under the left end of the transverse installation box 205 and fixed to the axle of the driven wheel 204, a connecting rod 207 fixed to the bottom of the circular table connecting seat 206 and a positioning plug block 208 fixed to the bottom of the connecting rod 207. The driving wheel 203 is rotated on the inside right end of the transverse installation box 205, the driven wheel 204 is rotated on the inside left end of the transverse installation box 205, the driving part 201 is fixed on the bottom of the right end of the transverse installation box 205, the driving part is the drive motor, and the connecting rod 207 is rotated with the cylinder cover 209 through the bearing.

The hydraulic cylinder 101 pushes the transverse installation box 205 up and down, thereby driving the connecting rod 207 and the cylinder cover 209 up and down, so that the cylinder cover 209 cover can be connected to the material cylinder 401 or away from the material cylinder 401, and the connecting rod 207 is connected to the detachable stirring assembly 3;

The detachable stirring assembly 3 is connected and fixed with the agitator output assembly, which drives the agitator output assembly to rotate and drives the detachable stirring assembly 3 to disperse and homogenize the solid-liquid mixture;

The detachable stirring assembly 3 comprises a butt post 302 with slot 301, a mixing rod 303 fixed under the butt post 302, two sets of dispersing disks 304 symmetrically fixed on the outer surface of the mixing rod 303, a sleeve 311 with a limit socket attached to the outer side of the bottom end of the mixing rod 303 and secured by locking screw 305, and a sleeve 311 arranged on the left and right sides of the sleeve 311 Two sets of inverted U-shaped mounting plates 306, two side plates 307 fixed to the outer side of the top of two sets of inverted U-shaped mounting plates 306 and in combination with the inverted U-shaped mounting plates 306 to form a frame type mixing rod, two bottom scraper plates 308 bolted to the bottom of the inverted U-shaped mounting plate 306 and used to scrape the material cylinder 401 bottom wall adhesive, bolted to the outer side of two side plates 307 and used side scraper plate 309 of the material glued to the side wall of the material cylinder 401 and two sets of fork stirring blades 310 which are symmetrical front and rear and are fixed connected with the side plate 307;

The flanging of the outer sides of the two side plates 307 is connected with the flanging screw on the butt plate 312 outside the top of the mixing rod 303 by bolts. The top of each set of inverted U-shaped mounting plates 306 is fixed connected with the reinforcing plate 313 connected with the sleeve 311, and the sleeve 311 is limited below the limit ring 314 on the outer surface of the mixing rod 303. Since the flanging of two side plates 307 is connected with the flanging screw on the butt plate 312, it is convenient to remove two side plates 307 and two sets of inverted U-shaped mounting plates 306 separately for replacing the scraper or cleaning the adhesive material.

The hydraulic cylinder 101 drives the detachable stirring assembly 3 up and down, saving height space and convenient operation. The external design of the detachable stirring assembly 3 is a frame type flipping mixing, the high shear dispersion of the middle dispersing disk 304, so that the solid liquid of the medium and high viscosity material is mixed, and the fork stirring blade 310, the dispersion mixing can be uniform, to achieve the ideal mixing effect of the material, the mixing effect is good, the homogenization effect is good;

After positioning plug block 208 is inserted into slot 301, secure positioning plug block 208 to butt post 302 by using bolts and nuts that penetrate positioning plug block 208 and butt post 302.

The positioning plug block 208 is inserted into slot 301 and secured by nuts to facilitate the installation and removal of detachable stirring assembly 3 and the removal and cleaning of detachable stirring assembly 3.

The flip-type material cylinder assembly 4 comprises material cylinder 401, the detachable stirring assembly 3 inserted into or away from material cylinder 401 under the action of hydraulic cylinder 101, and the detachable stirring assembly 3 inserted into material cylinder 401 is used to mix the solid-liquid mixture in material cylinder 401.

The flip-type material cylinder assembly 4 comprises a flip plate 404 fixed at the bottom of the material cylinder 401 and a push assembly 405 pushing the flip plate 404. The bottom of the flip plate 404 is arranged vertically on the left side of three sets of first convex font blocks 406, and the bottom of the flip plate 404 and located on the right side of the three sets of first convex font blocks 406 are provided with three sets of second convex font blocks 407. Three groups of second convex font blocks 407 are fixed through the longitudinal axis 408;

The drive assembly 405 comprises two U-shaped fixing slots 410 arranged symmetrically front and rear, two first rectangular slots 411 fixed on the left end of the top of the two U-shaped fixing slots 410, three sets of bearing blocks 412 fixed on the top of the two first rectangular slots 411 and arranged longitudinally, a rotating shaft 413 connected to the three sets of bearing blocks 412, and two first rectangular slots 411 The L-type fixing seat 414, the motor 415 fixed on the top of the L-type fixing seat 414, the worm gear and worm reducer 416 connected with the output shaft drive of the motor 415, and the force arm connecting rod 417 fixed with the output shaft of the worm gear and worm reducer 416;

The sleeve ring 419 on the force arm connecting rod 417 is rotated to the outer side of the longitudinal shaft 408, and the three sets of first convex font block 406 are fixed to the outer side of the rotating shaft 413;

The left and right ends of the two U-shaped fixing slots 410 are fixed with support foot 418, the two first convex font blocks 406 on the front and back sides are respectively fixed with two square fixing plates 420 on the external side, and a guide block 422 is fixed on the vertical plate 421 at the bottom of the two square fixing plates 420. The connecting block 423 fixed outside the left end of the two U-shaped fixing slots 410 is fixed connected with the two curved guide plates 424 respectively. The guide block 422 and the curved guide plate 424 are matched with the limit guide slide, and the curved guide plate 424 is provided with the arc-shaped guide through-hole slot 425 matching guide slide with the guide block 422. The top of the turnover plate 404 is provided with a positioning and fixing part in coordination with the material cylinder, and the top right end of the two U-shaped fixing slots 410 is also fixed with a second rectangular slot 426.

The motor 415 drives the worm gear and worm reducer 416 to push the force arm connecting rod 417 to open and fold, so that the force arm connecting rod 417 is connected with the longitudinal shaft 408 through the sleeve ring 419, which can push the vertical shaft 408, and the turnover plate 404 is flipped or flat, under the action of the motor 415 and the worm gear and worm reducer 416, It can achieve the function of self-locking, and smoothly flip the turning plate 404, and the lever structure of the force arm connecting rod 417 connecting the longitudinal axis 408 is a labor saving structure. After the discharge of the material cylinder 401, it can be turned over and easy to clean. Compared with the hydraulic rod lifting, the smooth performance of the turning plate 404 during the flipping process is better, and the stability of the material cylinder 401 during the flipping process is better. Flipping is more convenient, will not produce large vibration in the flipping process, more peaceful and stable.

### Example 2

Preparation of zinc oxide slurry B: 128 kg of zinc oxide, swell with 360 kg of water, stir to disperse completely, filter to remove coarse impurities, and add water if the viscosity is too high to maintain fluidity.

25 kg of organic amine corrosion inhibitor dimethylethanolamine, 600 kg of water, 5 minutes to dissolve, 35 kg of 85% phosphoric acid, add and stir for 5 minutes. &nbsp; After 100 kg of vermiculite powder and 300 kg of water are made into vermiculite slurry, the two are mixed at high speed for 30 minutes and stirred at low speed for 2 hours. The organic amine corrosion inhibitor is grafted with vermiculite through the end hydroxyl condensation reaction with phosphoric acid, and 121 kg of inorganic acid phosphoric acid is added along with zinc oxide slurry B. The slurry is stirred at medium speed for 30 minutes and dispersed and ground at high speed for 30 minutes. Add 10.1 kg of rare earth cerium oxide and 16 kg of molybdic acid, continue high-speed dispersion grinding for 30 minutes, after 4 hours of reaction, washing and centrifuging three times, after drying at 75° C., grinding to less than 325 mesh. A high-speed homogenizer for solid-liquid dispersion used in high-speed dispersion is shown in FIG. 4-15 and is the same as Example 1.

### Example 3

Preparation of magnesium hydroxide slurry C: swell 92 kg of magnesium hydroxide with 360 kg of water, stir to disperse completely, filter to remove coarse impurities, and add water if the viscosity is too high to maintain fluidity.

20.7 kg of organic amine inhibitor 8-hydroxyquinoline, 600 kg of water, 5 minutes to dissolve, 35 kg of 85% phosphoric acid, add and stir for 5 minutes. After 100 kg of 325 mesh mica powder and 300 kg of water were made into mica slurry, the two were mixed at high speed for 30 minutes and stirred at low speed for 2 hours. The organic amine corrosion inhibitor and mica were grafted with phosphoric acid through end-face hydroxyl condensation reaction, and 121 kg of inorganic acid phosphoric acid was added along with magnesium hydroxide slurry C, stirring at medium speed for 30 minutes and dispersing and grinding at high speed for 30 minutes. Add 6 kg of rare earth strontium oxide and 21.9 kg of ammonium tungstate, continue to disperse and grind at high speed for 30 minutes, after 4 hours of reaction, wash and centrifuge three times, dry at 320° C. and crush to less than 325 mesh.

### Example 4

Preparation of barium hydroxide slurry D: 270 kg of barium hydroxide, swell with 540 kg of water, stir to disperse completely, filter to remove coarse particle impurities, and add water if the viscosity is too high to maintain fluidity.

After 1000 kg of 325 mm kaolin powder and 300 kg of water were made into kaolin slurry, the two were mixed at high speed for 30 minutes, stirred at low speed for 2 hours, added 121 kg of inorganic acid phosphate, and then added barium hydroxide slurry D, stirred at medium speed for 30 minutes, dispersed and ground at high speed for 30 minutes, added 22 kg of rare earth prasedymium oxide and 8.9 kg of phosphoric acid. Continue the high speed dispersion grinding for 30 minutes, after 4 hours of reaction, wash and centrifuge three times, and then pulverize to less than 325 mesh after drying at 75° C.

### Example 5

Preparation of aluminum hydroxide slurry E: 123 kg of aluminum hydroxide, swell with 540 kg of water, stir to disperse completely, filter to remove coarse impurities, and add water if the viscosity is too high to maintain fluidity.

18 kg of organic amine inhibitor melamine, 600 kg of water, 5 minutes to dissolve, 35 kg of 85% phosphoric acid, add and stir for 5 minutes. 100 kg 325 mesh Aemon mixed layer soil powder and 300 kg water were used to make Aemon mixed layer soil slurry, which was mixed at high speed for 30 minutes and stirred at low speed for 2 hours. The organic amine corrosion inhibitor was grafted with Aemon mixed layer soil through end-face hydroxyl condensation reaction with phosphoric acid, and 121 kg of inorganic acid phosphate was added, followed by aluminum hydroxide slurry E, and stirred at medium speed for 30 minutes. High-speed dispersion grinding for 30 minutes, adding 22 kg of rare earth lanthanum oxide, 8.9 kg of phosphoric acid, continue high-speed dispersion grinding for 30 minutes, after 4 hours of reaction, washing centrifuge three times, drying at 75° C. and crushing to less than 325 mesh.

### Example 6

Preparation of ferric oxide slurry F: 252 kg of ferric oxide, swollen with 810 kg of water, stirred to disperse completely, filtered to remove coarse impurities, if the viscosity is too high, add water to maintain fluidity.

16.8 kg of organic amine corrosion inhibitor phenyltriazole, 600 kg of water, 5 minutes to dissolve, 35 kg of 85% phosphoric acid, add and stir for 5 minutes. After 100 kg 325 mesh chlorite powder and 300 kg water were made into chlorite slurry, the two were mixed at high speed for 30 minutes and stirred at low speed for 2 hours. The organic amine corrosion inhibitor was grafted with chlorite through the end hydroxyl condensation reaction with phosphoric acid, and 121 kg of inorganic acid phosphoric acid was added along with the ferric oxide slurry F, stirring at medium speed for 30 minutes and grinding at high speed for 30 minutes. Add 7 kg of rare earth strontium oxide and 3 kg of boric acid, continue to disperse and grind at high speed for 30 minutes, after 4 hours of reaction, wash and centrifuge three times, and then grind to less than 325 mesh after drying at 75° C.

### Example 7

Preparation of zinc oxide/barium hydroxide slurry G: 64 kg of zinc oxide, 134 kg of barium hydroxide, swollen with 810 kg of water, stir to disperse completely, filter to remove coarse particle impurities, and add water if the viscosity is too high to maintain fluidity.

16.8 kg of organic amine corrosion inhibitor phenimiazole, 600 kg of water, 5 minutes to dissolve, 35 kg of 85% phosphoric acid, add and stir for 5 minutes. 100 kg 325mesh mica powder and 300 kg water were mixed into chlorite slurry for 30 minutes at high speed and stirred at low speed for 2 hours. Phosphoric acid was grafted with organic amine corrosion inhibitor and mica through end-face hydroxyl condensate reaction, and 121 kg inorganic phosphoric acid was added, followed by zinc oxide/barium hydroxide slurry G, and stirred at medium speed for 30 minutes. High speed dispersion grinding for 30 minutes, adding 11.6 kg of rare earth cerium oxide, 16.2 kg of molybdic acid, continue high speed dispersion grinding for 30 minutes, after 4 hours of reaction, washing centrifuge three times, after drying at 75° C., grinding to less than 325 mesh.

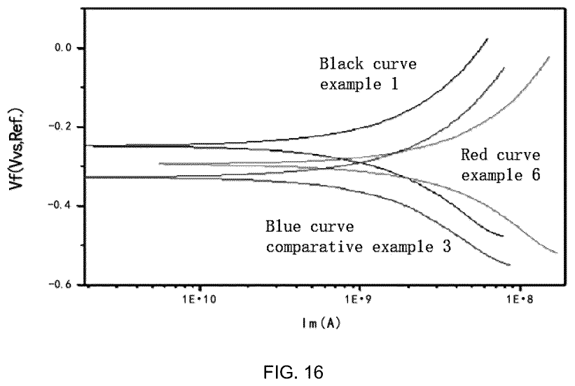

FIG. 16 is the corrosion rate curve of the product coating of Example 1 of the invention; The vertical axis represents the potential value, and the horizontal axis represents the corrosion current. The size of the corrosion rate can indicate the speed or speed of the corrosion tendency of the coating. The greater the corrosion potential, the less easy the corrosion and the better the corrosion resistance.

TABLE 2
Formulations of examples :

| | Active | | | | Rare earth |
|---|---|---|---|---|---|
| | oxides or | | | | oxides or their |
| | their | Organic | | Inorganic | sulfuric, nitric |
| | sulfuric, nitric and | amine | | acid or | and |
| | hydrochloride | corrosion | Layered | inorganic | hydrochloride |
| Number | acids | inhibitor | silicate | acid salt | acids |
| Exam- | Calcium | Melamine | montmorillonite | Phosphoric | Cerium |
| ple 1 | hydroxide | | | acid | oxide |
| | (calcium | | | | (cerium |
| | oxide) | | | | hydroxide) |
| Exam- | Zinc oxide | ethanola | vermiculite | Molybdic | Lanthanum |
| ple 2 | | mines | | acid | oxide |
| | | | | | (lanthanum |
| | | | | | hydroxide) |
| Exam- | Magnesium | 8- | mica | Ammonium | Strontium |
| ple 3 | hydroxide | hydroxyquinoline | | tungstate | oxide |
| | (magnesia) | | | | (strontium |
| | | | | | hydroxide) |
| Exam- | Barium | / | kaolin | Phosphoric | Praseodymium |
| ple 4 | hydroxide | | | acid | (praseodymium |
| | | | | | hydroxide) |
| Exam- | Aluminum | Melamine | Illite, | Boric acid | Lanthanum |
| ple 5 | hydroxide | | Aemon | | oxide |
| | (alumina) | | mixed layer | | |
| Exam- | Iron oxide | Benzotria | chlorite | Boric acid | Strontium |
| ple 6 | | zoles | | | oxide |
| Exam- | Zinc | Benzimid | mica | Molybdic | Cerium oxide |
| ple 7 | oxide/barium | azoles | | acid | |
| | hydroxide | | | | |

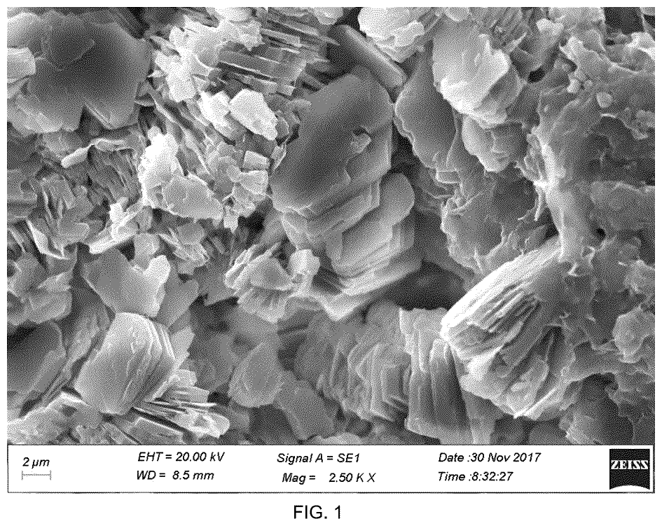

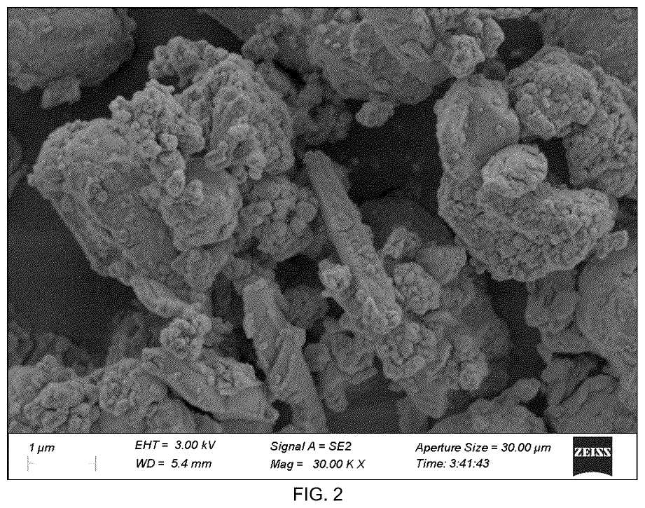

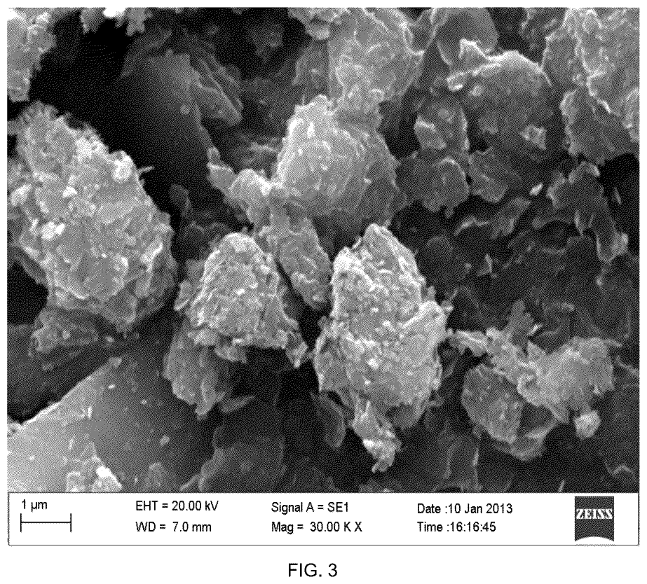

Among them, the structural characterization diagram is shown in FIG. 1-4; FIG. 1 is the SEM electron microscope image of mica template agent; FIG. 2 shows the SEM image of mica template after liquid phase chemical deposition. The particle size of cerium phosphate doped nano-calcium phosphate on the surface of the template is about 30-100 nm. FIG. 3 shows the SEM image of bentonite template agent. FIG. 4 shows the SEM image after liquid phase chemical deposition of bentonite template agent. The particle size of cerium phosphate doped nano-calcium phosphate on the template surface is about 30-100 nm.

Comparative anti-rust pigments and preparations are described in Table 3.

TABLE 3
Comparative example:

| | |
|---|---|
| Comparative | 1000 kg of water, adding 5 kg of |
| example 1 | BYK-190 dispersant, 100 kg of |
| | zinc phosphate and 1 kg of |
| | benzotriazole were dispersed and |
| | mixed, and ground with a rod and |
| | pin sander and 0.1 mm-0.3 mm |
| | zirconium bead sanding for |
| | 60 minutes until the fineness is less |
| | than 100 nm |
| Comparative | 9.9 kg of Iriodin ® 9504WR, 12.8 kg |
| example 2 | of metaphosphate, 7.22 kg of |
| | zinc phosphate and 6.45 kg of titanium |
| | pale iron were mixed evenly |
| Comparative | 5 kg of montmorillonite template |
| example 3 | was dispersed in 50 kg of water, |
| | 56 kg of calcium oxide was dispersed |
| | in 2000 L of water, mixed with |
| | two suspensions, 65 kg of phosphoric |
| | acid was added within 2 |
| | minutes at 470 revolutions at 22° C., |
| | dehydrated and dried at 105° C., |
| | and ground to less than 120 mesh. |
| Comparative | Zinc phosphate (Guangxi Sanjing |
| example 4 | Technology Co., LTD.) |
| Comparative | Zinc phosphomolybdate (Jiangsu |
| example 5 | Shenlong Zinc Industry Co., LTD.) |
| Comparative | Strontium chromic yellow (strontium |
| example 6 | chromate), France SNCZ L203E |

### Testing in Acrylic Paint Systems

Prepare water-based white slurry and white paint according to the formula in the following table, and test the salt spray performance.

TABLE 4
Formula of water-based white pulp

| Number | Ingredients | Additive amount | Remark |
|---|---|---|---|
| 1 | Water | 10 | Disperse to fine |
| 2 | Dispersant | 1.5 | |
| 3 | Defoamer | 0.2 | |
| 4 | Titanium dioxide | 12 | |
| 5 | Talc powder | 5 | |
| 6 | Barium sulfate | 20 | |
| 7 | Antirust pigment | 5 | |
| 8 | Water | 2 | |
| 9 | Total | 55.7 | |

TABLE 5
Water-based acrylic formulations

| Number | Ingredients | Additive amount | Remark |
|---|---|---|---|
| 1 | Water paste + anti- | 55 | Disperse evenly and |
| | rust pigment | | stir at 800 r/min |
| 2 | Acrylic emulsion | 55 | for 15 |
| 3 | Film forming agent | 3 | minutes |
| 4 | Defoamer | 0.1 | |
| 5 | Levelling agent | 0.2 | |
| 6 | Anti-flash rust agent | 0.5 | |
| 7 | PU278 Polyurethane | 0.1 | |
| | Total | 113.9 | |

In accordance with ISO 7253 neutral salt spray resistance test standard requirements, coating with wire rod coater on the treated metal steel plate substrate, dry film thickness of 60 um, according to ISO4628 color paint and varnish coating performance test after the rating method standard to determine the rust, bubbles and peeling conditions.

TABLE 6
Salt spray resistance test of acrylic coatings

| Number | 48 h | 96 h | 240 h |
|---|---|---|---|
| Example 1 | Blistering 0 (S0), | Blistering 0 (S0), | Blistering 0 (S0), |
| | rusting 0 (S0) | rusting 0 (S0) | rusting 0 (S0) |
| Example 2 | Blistering 0 (S0), | Blistering 0 (S0), | Blistering 0 (S0), |
| | rusting 0 (S0) | rusting 0 (S0) | rusting 0 (S0) |
| Example 3 | Blistering 0 (S0), | Blistering 0 (S0), | Blistering 0 (S0), |
| | rusting 0 (S0) | rusting 0 (S0) | rusting 0 (S0) |
| Example 4 | Blistering 0 (S0), | Blistering 0 (S0), | Blistering 0(S0), |
| | rusting 0 (S0) | rusting 0 (S0) | rusting 1(S1) |
| Example 5 | Blistering 0 (S0), | Blistering 0 (S0), | Blistering 1(S1), |
| | rusting 0 (S0) | rusting 0 (S0) | rusting 0(S0) |
| Example 6 | Blistering 0 (S0), | Blistering 0 (S0), | Blistering 0 (S0), |
| | rusting 0 (S0) | rusting 0 (S0) | rusting 0 (S0) |
| Example 7 | Blistering 0 (S0), | Blistering 0 (S0), | Blistering 0 (S0), |
| | rusting 0 (S0) | rusting 0 (S0) | rusting 0 (S0) |
| Comparative | Blistering 0 (S0), | Blistering 1(S1), | Blistering 3(S2), |
| example 1 | rusting 0 (S0) | rusting 0(S0) | rusting 3(S3) |
| Comparative | Blistering 0 (S0), | Blistering 0 (S0), | Blistering 1(S1), |
| example 2 | rusting 0 (S0) | rusting 0 (S0) | rusting 0(S0) |
| Comparative | Blistering 0 (S0), | Blistering 1(S1), | Blistering 3(S3), |
| example 3 | rusting 0 (S0) | rusting 0(S0) | rusting 3(S3) |
| Comparative | Blistering 0 (S0), | Blistering 3(S2), | Blistering 5(S4), |
| example 4 | rusting 0 (S0) | rusting 2(S3) | rusting 4(S4) |
| Comparative | Blistering 0 (S0), | Blistering 0 (S0), | Blistering 1(S1), |
| example 5 | rusting 0 (S0) | rusting 0 (S0) | rusting 2(S1) |
| Comparative | Blistering 0 (S0), | Blistering 0 (S0), | Blistering 1(S1), |
| example 6 | rusting 0 (S0) | rusting 0 (S0) | rusting 0(S0) |
| Blank | Blistering 4(S3), | Blistering 5(S3), | Blistering 5(S4), |
| | rusting 3(S2) | rusting 4(S4) | rusting 5(S5) |

### Salt Spray Resistance Testing in Epoxy Coating Systems

Prepare water-based white slurry and white paint according to the formula in the following table, and test the salt spray resistance.

TABLE 7
Formula of water-based white pulp

| Number | Ingredients | Additive amount | Remark |
|---|---|---|---|
| 1 | Water | 10 | Disperse to fine |
| 2 | Dispersant | 1.5 | |
| 3 | Defoamer | 0.2 | |
| 4 | Titanium dioxide | 12 | |
| 5 | Talc powder | 5 | |
| 6 | Barium sulfate | 17 | |
| 7 | Antirust pigment | 8 | |
| 8 | Water | 2 | |
| 9 | Total | 55.7 | |

TABLE 8
Water-based epoxy formulation

| Number | Ingredients | Additive amount | Remark |
|---|---|---|---|
| 1 | Water paste + anti-rust | 55 | Disperse evenly and |
| | pigment | | stir at 800 r/min |
| 2 | Epoxy emulsion | 43 | for 15 |
| 3 | DPNB | 2 | minutes |
| 4 | Defoamer | 0.1 | |
| 5 | Levelling agent | 0.2 | |
| | Total | 100.3 | |

TABLE 9
Salt spray resistance test of epoxy coatings
(Among them, the ratio of epoxy coating to curing agent
is 100:10, and the dry film thickness is 75 um)

| Number | 480 h | 720 h | 960 h |
|---|---|---|---|
| Example 1 | Blistering 0(S0), | Blistering 0(S0), | Blistering 0(S0), |
| | rusting 0(S0) | rusting 0(S0) | rusting 0(S0) |
| Example 2 | Blistering 0(S0), | Blistering 0(S0), | Blistering 0(S0), |
| | rusting 0(S0) | rusting 0(S0) | rusting 0(S0) |
| Example 3 | Blistering 0(S0), | Blistering 0(S0), | Blistering 1(S1), |
| | rusting 0(S0) | rusting 0(S0) | rusting 1(S1) |
| Example 4 | Blistering 0(S0), | Blistering 1(S1), | Blistering 2(S2) |
| | rusting 0(S0) | rusting 0(S0) | rusting 0(S0) |
| Example 5 | Blistering 0(S0), | Blistering 0(S0), | Blistering 0(S0), |
| | rusting 0(S0) | rusting 0(S0) | rusting 0(S0) |
| Example 6 | Blistering 0(S0), | Blistering 0(S0), | Blistering 0(S0), |
| | rusting 0(S0) | rusting 0(S0) | rusting 1(S1) |
| Example 7 | Blistering 0(S0), | Blistering 0(S0), | Blistering 0(S0), |
| | rusting 0(S0) | rusting 0(S0) | rusting 0(S0) |
| Comparative | Blistering 0(S0), | Blistering 0(S0), | Blistering 1(S1), |
| example 1 | rusting 0(S0) | rusting 0(S0) | rusting 1(S1) |
| Comparative | Blistering 0(S0), | Blistering 0(S0), | Blistering 1(S1), |
| example 2 | rusting 0(S0) | rusting 0(S0) | rusting 1(S1) |
| Comparative | Blistering 0(S0), | Blistering 2(S2), | Blistering 4(S2), |
| example 3 | rusting 0(S0) | rusting 0(S0) | rusting 5(S2) |
| Comparative | Blistering 0(S0), | Blistering 2(S2), | Blistering 4(S2), |
| example 4 | rusting 0(S0) | rusting 0(S0) | rusting 5(S3) |
| Comparative | Blistering 0(S0), | Blistering 1(S1), | Blistering 3(S2), |
| example 5 | rusting 0(S0) | rusting 0(S0) | rusting 3(S3) |
| Comparative | Blistering 0(S0), | Blistering 0(S0), | Blistering 2(S4), |
| example 6 | rusting 0(S0) | rusting 0(S0) | rusting 1(S1) |
| Blank | Blistering 1(S1), | Blistering 3(S2), | Blistering 5(S5), |
| | rusting 0(S0) | rusting 0(S0) | rusting 3(S4) |

The water-based alkyd paint is prepared according to Table 10. With low viscosity, it can be sprayed directly on the plate. After being placed at room temperature for 7 days, it is baked at 80° C. for 1 hour and placed in 5% salt water to test its salt water resistance.

TABLE 10
Formula of alkyd paint

| Number | Ingredients | Additive amount | Technology | Remark |
|---|---|---|---|---|
| 1 | water | 15 | 1-7 items | |
| 2 | dispersant | 1.0 | dispersed | |
| 3 | defoamer | 0.5 | evenly, fast | |
| 4 | Iron red | 10 | hand dispersed | |
| 5 | Antirust pigment | 4.7 | 2 h, add 8-10 | |
| 6 | Barium sulfate | 12 | items | |
| 7 | Talc powder | 10 | | |
| 8 | Alkyd resin | 45 | | |
| 9 | Alkyd resin | 1.5 | | |
| 10 | Levelling agent | 0.3 | | |
| | Total | 100 | | |

The specific embodiment is only the interpretation of the invention, it is not a limitation of the invention, the technical personnel in the field after reading the specification can make no creative contribution to the embodiment according to the need to modify, but as long as within the scope of the claims of the invention are protected by the patent law.

1. Modified layered silicate novel barrier and shielding pigment, it is characterized by: it uses layered silicate with exchangeable anti-corrosion ions as a template, and uses metal oxides or their salts or hydroxides, inorganic acid or inorganic acid salt to synthesize nano-spherical phosphates, molybdates, borate or tungstate by liquid deposition, and by doping modification with rare earth cerium, strontium, lanthanum or praseodymium to obtain the pigment;
specifically, the organic amine inhibitor was grafted with layered silicate by condensation reaction using phosphoric acid, and a metathesis reaction occurs between the metal oxide or hydroxide or its sulfates, nitrate and hydrochloride and the inorganic acid or inorganic acid salt, generate nanoscale phosphate, molybdate, tungstate or borate, deposit on the surface of layered silicate sheets, and select rare earth oxides or their sulfates, nitrates and hydrochloride for doping and modification;
the preparation method of modified layered silicate novel barrier and shielding pigments includes the following steps:
a. prepare metal oxides or their sulfates, nitrates and hydrochloride or hydroxide in 30-200 parts by weight, dissolve with 150-800 parts by weight of water, disperse in high speed, filtrate to remove coarse particles of impurities, replenish water to maintain flow capacity if viscosity is too high;
b. prepare 10-40 parts by weight of organic amine corrosion inhibitor, 100-600 parts by weight of water, dissolve in 3-7 minutes, 20-80 parts by weight of 80-90% phosphoric acid, add and stir for 3-8 minutes; 40-150 parts by weight of layered silicate and 200-750 parts by weight of water to make silicate slurry, disperse the two at high speed for 25-35 minutes, stir at low speed for 1-3 hours, and add 50-220 parts by weight of inorganic acid or inorganic acid salt, add the slurry prepared in step a, stir for 20-40 minutes, grind for 25-35 minutes, add 3.5-21 parts by weight of rare earth oxides or their sulfates, nitrates and hydrochlorides, 3-22 parts by weight of inorganic acid or inorganic acid salt, continue to disperse at high speed, react for 3-5 hours, wash and centrifuge, dry and grind at 70-320° C.;
the inorganic acid in step b is phosphoric acid, molybdic acid, tungstic acid or boric acid.

2. Modified layered silicate novel barrier and shielding pigment according to claim 1, it is characterized by: the metal oxide or hydroxide in step a is one or more of calcium hydroxide, calcium oxide, magnesium hydroxide, magnesium oxide, barium hydroxide, aluminum hydroxide, aluminum oxide, and iron oxide.

3. Modified layered silicate novel barrier and shielding pigment according to claim 2, it is characterized by: the organic amine corrosion inhibitor in step b is one or more of melamine, ethanolamines, benzotriazoles or benzimidazoles.

4. Modified layered silicate novel barrier and shielding pigment according to claim 3, it is characterized by: the layered silicate in step b is one or more of montmorillonite, vermiculite, mica, kaolin, illite, aemon mixed layer or chlorite.

5. Modified layered silicate novel barrier and shielding pigment according to claim 4, it is characterized by: the rare earth oxide in step b is one or more of cerium oxide, lanthanum oxide, strontium oxide or praseodymium oxide.

6. Modified layered silicate novel barrier and shielding pigment according to claim 1, it is characterized by: solid-liquid dispersion high-speed homogenizers used for high-speed dispersion include:
lifting mechanism (1), the lifting mechanism (1) is a hydraulic cylinder (101);
rotary drive assembly (2), the rotary drive assembly (2) is fixed on the top of the hydraulic cylinder (101), the hydraulic cylinder (101) pushes the rotary drive assembly (2) to perform lifting movement, and the rotary drive assembly (2) includes the driving part (201), belt (202), driving wheel (203) and driven wheel (204), the driving part (201) drives the driving wheel (203) to rotate, and the driving wheel (203) drives the driven wheel (204) through the belt (202) rotate, the output shaft of the driven wheel (204) is connected with the agitator output assembly, thereby driving the agitator output assembly to rotate;
detachable stirring assembly (3), the detachable stirring assembly (3) is connected and fixed with the agitator output component, the rotation of the stirrer output component drives the detachable stirring assembly (3) to rotate to disperse the solid-liquid mixture evenly;
flip-type material cylinder assembly (4), the flip-type material cylinder assembly (4) includes a material cylinder (401), and the detachable stirring assembly (3) is inserted into or away from the material cylinder (401), under the push of the hydraulic cylinder (101) when the detachable stirring assembly (3) is inserted into the material cylinder (401), it is used to mix the solid-liquid mixture in the material cylinder (401).

7. Modified layered silicate novel barrier and shielding pigment according to claim 6, it is characterized by: the detachable stirring assembly (3) includes a butt post (302) with a slot (301), a mixing rod (303) fixed below the butt post (302), two sets of dispersing disks (304) symmetrically fixed on the outer side of the mixing rod (303), the sleeve (311) attached to the outer side of the bottom end of the mixing rod (303) and secured by locking screw (305), two sets of inverted U-shaped mounting plates (306) arranged on the left and right sides of the sleeve (311), two side plates (307) fixed outside the top of two sets of inverted U-shaped mounting plates (306) and fitted with the inverted U-shaped mounting plates (306) to form a frame type mixing rod, two bottom scraper plates (308) bolted to the bottom of the inverted U-shaped mounting plate (306) and used to glue the bottom wall of the material cylinder (401), a side scraper plate (309) bolted to the outer sides of the two side plates (307) and used to scrape the material attached to the side wall of the material cylinder (401) and two sets of fork stirring blades (310) which are symmetrical front to back and are fixed to the side plate (307);
the flanging of the outer sides of the two side plates (307) is connected with the flanging of the butt plate (312) on the outer side of the top of the mixing rod (303) by bolts, and the top of each set of the inverted U-shaped mounting plate (306) is fixed connected with a reinforcing plate (313) connected with the sleeve (311), the sleeve (311) limit is located below the limit ring (314) on the outer surface of the mixing rod (303).
